(19) United States
(12) Patent Application Publication
(10) Pub. No.: US 2019/0146003 A1
(43) Pub. Date: May 16, 2019

(54) MICROMECHANICAL INERTIAL SENSOR

(71) Applicant: Robert Bosch GmbH, Stuttgart (DE)

(72) Inventor: Jochen Reinmuth, Reutlingen (DE)

(21) Appl. No.: 16/190,700

(22) Filed: Nov. 14, 2018

(30) Foreign Application Priority Data
Nov. 16, 2017 (DE) 102017220412.5

(51) Int. Cl. G01P 15/125

(52) U.S. Cl. CPC G01P 15/125; G01P 2015/0814

(57) ABSTRACT

A micromechanical inertial sensor, having a movable seismic mass fixed in position on a substrate and having comb-like first electrodes; second electrodes fixed in position on the substrate, the electrodes being designed in such a way that, when no external acceleration is applied, an overlap of the first electrodes with the second electrodes in the sensing direction is definably small and amounts to less than approx. 35%, preferably less than approx. 25%.

### CROSS REFERENCE

The present application claims the benefit under 35 U.S.C. § 119 of German Patent Application No. DE 102017220412.5 filed on Nov. 16, 2017, which is expressly incorporated herein by reference in its entirety.

### FIELD

The present invention relates to a micromechanical inertial sensor. Furthermore, the present invention relates to a method for manufacturing a micromechanical inertial sensor.

### BACKGROUND INFORMATION

Micromechanical xy-inertial sensors having MEMS structures have been known for a long time. These may have a seismic mass developed in a functional layer, which is anchored on the substrate via springs. The deflection of the mass is normally measured via electrodes designed as plate-type capacitors. The deflection changes the interspace of the plates of the capacitor and the resulting change in the capacitance is measured.

### SUMMARY

It is an object of the present invention to provide a micromechanical inertial sensor having an improved sensing behavior.

According to a first aspect of the present invention, the objective may be achieved by a micromechanical inertial sensor, which includes, for example:
a movable seismic mass fixed in position on a substrate and having comb-like first electrodes;
second electrodes fixed in position on the substrate, the electrodes being designed in such a way that, when no external acceleration is applied, an overlap of the first electrodes with the second electrodes in the sensing direction is definably small and amounts to less than approx. 35%, preferably less than approx. 25%.

Advantageously, with the aid of the comb-shaped electrode structures it is possible to generate a very uniform linear electrical signal. In a comb structure, the change in capacitance per deflection is defined by the comb interspace and the maximum deflection by the length of the comb and the comb overlap in the normal state. In a conventional plate-type capacitor system, by contrast, both the change in capacitance per deflection as well as the maximum deflection are defined by the plate interspace.

Advantageously, it is in this manner also possible to provide a far-reaching insensitivity of the sensor to deformations of the substrate.

A plate-type capacitor system normally uses two differentially arranged stationary electrodes of equal size. When the seismic mass is deflected, the distance of the mass from the first electrode increases in the same measure as it decreases with respect to the second electrode. In the position of rest, the seismic mass lies exactly in the middle between the two electrodes. An electrical evaluation voltage is usually applied on the electrodes, which exerts a force on the seismic mass. Due to the symmetrical arrangement, the forces exerted by the two electrodes on the seismic mass cancel each other. Due to the nonlinearity of the forces in a plate-type capacitor with the distance, the balance of forces is disturbed with a deflection of the seismic mass. After a certain point, the restoring force of the springs then no longer suffices and the seismic mass is pulled entirely onto the stationary electrode. This results in a collapse, and the seismic mass is greatly accelerated in the process and at high speed strikes either the stationary electrode or a stop structure especially provided for this purpose.

By contrast, the force in a comb structure is advantageously independent of the deflection. Advantageously, it is in this manner also possible to provide a far-reaching insensitivity of the micromechanical inertial sensor to the electrical evaluation voltage.

Furthermore, in this manner it is advantageously possible to prevent an impact at high speed, caused by the applied electrical voltage, on the stationary electrode or on a stop structure especially provided for this purpose.

In a plate-type capacitor system, the capacitance in the normal state is determined by the plate interspace. The change in capacitance per deflection is likewise determined by the plate interspace. In a comb system, the capacitance in the normal state is determined by the finger interspace and by the finger overlap in the normal state.

According to a second aspect of the present invention, the objective may be achieved by a method for manufacturing an micromechanical inertial sensor, having the steps:
providing a movable seismic mass fixed in position on a substrate and having comb-like first electrodes;
providing second electrodes fixed in position on the substrate, the electrodes being designed in such a way that, when no external acceleration is applied, an overlap of the first electrodes with the second electrodes in the sensing direction is definably small and amounts to less than approx. 35%, preferably less than approx. 25%.

Preferred developments of the micromechanical inertial sensor are described herein.

One advantageous development of the micromechanical inertial sensor is characterized by the fact that in the event of a maximum negative acceleration with respect to a measuring range of the inertial sensor the overlaps of the first electrodes with the second electrodes in the sensing direction are of such a kind that end sections of the first electrodes and of the second electrodes overlap in a definably small manner or that they are spaced apart from each other less than a distance between the end sections of the first and second electrodes.

This allows for a great electrical sensitivity of the sensor for the entire measuring range. In the event of negative accelerations that exceed the measuring range of the sensor, the electrodes may “emerge from one another” entirely. This advantageously allows for a deflection of the comb electrodes in the opposite direction, which extends further than what corresponds to the maximum measured acceleration, which makes it possible to save chip area while at the same time allowing, even in this comb structure, for a high capacitance change per deflection at a low base capacitance in this comb structure. Another advantageous development of the micromechanical inertial sensor is characterized by the fact that at least one section of the first and/or the second electrodes is not developed in parallel to the sensing direction and that the section that is not developed in parallel to the sensing direction does not mechanically limit the movement of the first and/or the second electrodes in the sensing direction.

This supports the fact that in a movement in the sensing direction a distance between the first and second electrode varies, which supports an increased sensitivity of the micromechanical inertial sensor. The non-parallel arrangement is implemented in such a way that the electrodes continue to be able geometrically to be fully immersed into one another or at least as far as the overlap in the normal state.

Another advantageous development of the micromechanical inertial sensor is characterized by the fact that at least one portion of the second electrodes is developed in such a way that a width of the second electrodes in the sensing direction behind a sensing range is designed to be uniformly wide or increasing in width. This supports a high sensing sensitivity of the micromechanical sensor.

Another advantageous development of the micromechanical inertial sensor is characterized in that the seismic mass is attached to the substrate by spring elements, the spring elements being designed in such a way that a spring stiffness in the sensing direction is definably soft and orthogonal to the sensing direction is designed to be definably hard. This makes it possible advantageously to provide a sensitivity of the sensor primarily in the sensing direction, whereas the sensor is largely insensitive in a direction orthogonal to the sensing direction.

Another advantageous development of the micromechanical inertial sensor is characterized by the fact that at least one portion of the first or the second electrode in a region of the overlap in the normal state is designed in such a way that the distance between the electrodes is reduced in a subsection when the electrodes are immersed into one another in the sensing direction. This also supports a high sensing sensitivity of the micromechanical inertial sensor.

Another advantageous development of the micromechanical inertial sensor is characterized by the fact that at least one portion of the first or the second electrodes in a region outside of the overlap in the normal state is designed in such a way that the distance between the electrodes is increased in a subsection when the electrodes are immersed into one another in the sensing direction. This makes it advantageously possible to reduce the electrical force in great deflections before the electrodes impact mechanically.

Another advantageous development of the micromechanical inertial sensor is characterized by the fact that stop elements are provided, the stop elements making it possible to limit an immersion depth of the second electrodes into the first electrodes. This advantageously helps to prevent the electrodes from striking against one another, by stopping them just prior to impact. This advantageously supports an improved sensing characteristic and an increased operational life of the inertial sensor. The stop structures may advantageously have an electrical potential that agrees with the electrical potential of the movable comb structure in order to prevent short circuits and prevent the structure from being held at the stop.

The present invention is described below in detail with additional features and advantages with reference to several figures. Identical or functionally identical elements bear the same reference symbols. The figures are intended in particular to elucidate the principles of the present invention and are not necessarily executed true to scale. For the sake of clarity, it may be provided that not all reference symbols are drawn in all figures.

Disclosed method features result analogously from corresponding disclosed device features and vice versa. This means in particular that features, technical advantages and embodiments concerning the method for manufacturing a micromechanical inertial sensor result in an analogous manner from corresponding embodiments, features and advantages concerning the micromechanical inertial sensor and vice versa.

### BRIEF DESCRIPTION OF THE DRAWINGS

FIG. 1 shows a cross-sectional view of a conventional micromechanical inertial sensor.

FIG. 2 shows a top view onto a conventional micromechanical inertial sensor.

FIG. 3 shows a top view onto a first specific embodiment of a micromechanical inertial sensor provided by the present invention.

FIG. 4 shows top views onto an electrode system of a specific embodiment of a micromechanical inertial sensor provided by the present invention.

FIG. 5 shows top views onto an electrode system of another specific embodiment of a micromechanical inertial sensor provided by the present invention.

FIG. 6 shows top views onto an electrode system of another specific embodiment of a micromechanical inertial sensor provided by the present invention.

FIG. 7 shows a basic sequence of a method for manufacturing a micromechanical inertial sensor provided by the present invention.

### DETAILED DESCRIPTION OF EXAMPLE EMBODIMENTS

The present invention provides a micromechanical inertial sensor having an improved sensing characteristic.

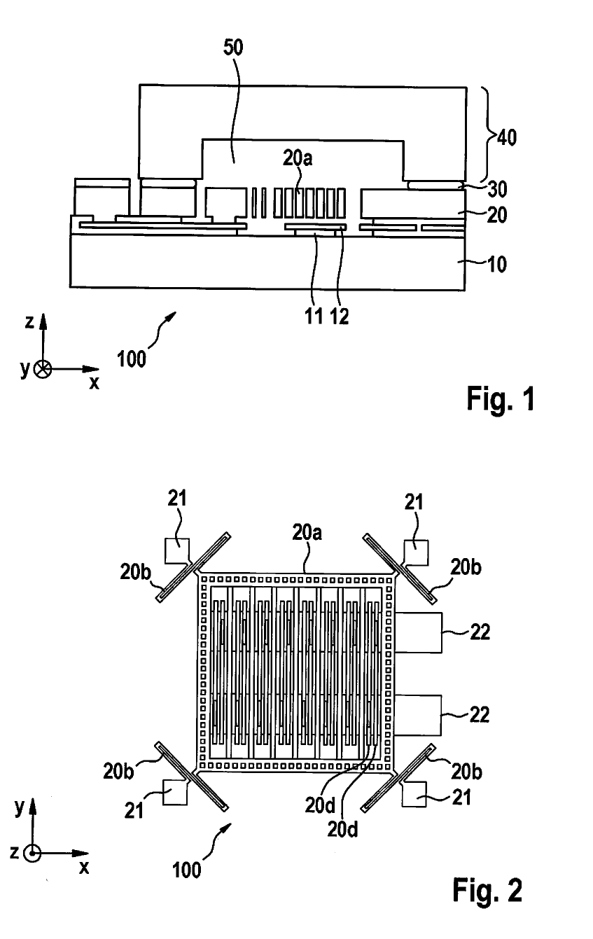

FIG. 1 shows a greatly simplified cross-sectional view of a conventional micromechanical inertial sensor 100. A movable MEMS structure or seismic mass 20a may be seen, which is etched out of a thick micromechanical second functional layer 20 made of polysilicon. These are situated above a thin buried first functional layer 12 made of polysilicon, the latter for its part being anchored by an oxide layer 11 on a substrate 10. An oxide layer is also provided between the two functional layers 12, 20.

The buried first functional layer 12 made of polysilicon acts as an electrical conductor track and/or as an electrode. The second micromechanical functional layer 20 is exposed via a trench process and an oxide-sacrificial layer method. The buried first functional layer 12 is electrically isolated from substrate 10 by an oxide 11. The conductor tracks and electrodes are designed to be so wide that they are not completely undercut in the oxide-sacrificial oxide etching step and are thus solidly anchored on substrate 10.

The movable seismic mass 20a produced in this manner is usually sealed by a cap wafer 40 in the further process sequence. Depending on the application, a suitable internal pressure is thereby enclosed within volume 50, the sealing occurring usually via a seal-glass bonding method or via an eutectic bonding method, e.g., using AIGe.

If an acceleration sensor is produced, then seismic mass 20a is usually produced in second functional layer 20, which is fixed in position on substrate 10 via spring elements 20b and connecting elements 21, which are usually also produced in the functional layer, as shown in the top view of FIG. 2. In order to be able to measure the free-standing mass in an externally applied acceleration, usually the capacitance change between electrode surfaces attached on seismic mass 20a and electrode surfaces anchored firmly on substrate 10 is detected.

In order to obtain an electrical signal that is as large as possible, electrodes 20d are situated in such a way that the distance between the electrodes and the seismic mass 20a changes in the event of an external acceleration. Electrical lines 22, which are situated in the buried polysilicon layer, are provided for electrically contacting electrodes 20d.

A disadvantage of this system may be that one obtains a highly non-linear electrical signal due to a dependency of the capacitance of a plate-type capacitor with respect to the reciprocal value of the plate spacing.

It may furthermore be disadvantageous that relatively small electrode spacings are required in order to obtain a large electrical signal. Deformations of the substrate as a result of influences from outside may change the electrode spacings minimally and consequently result in large, undesired electrical false signals.

Furthermore, sensors of this kind normally have a great tendency to stick, which cannot be avoided for systemic reasons, as will be explained below.

The detection principle has the result that the freedom of movement of seismic mass 20a is limited by stationary electrodes 20d. Seismic mass 20a is suspended on spring elements 20b that are as soft as possible in order to obtain a sensitive sensor. It is disadvantageous in this regard that seismic mass 20a may strike against the stationary electrodes 20d already at small overloads and that an electrical short circuit may arise in this manner between the two electrodes 20d.

Depending on the electronic evaluation circuit used, this may result in a destruction of the electronic evaluation circuit or in electrodes 20d being bonded to one another. For this reason the freedom of movement is usually limited further by another stationary structure that is at the same electrical potential as the movable structure, in order to avoid the effect described above.

The very limited freedom of movement, in combination with the requirement of a very soft suspension so as to achieve high sensitivities, has the result that the mechanical restoring forces of seismic mass 20a, when the latter is at the stop, are very low, and that it is possible that on the basis of the Van der Waals forces alone seismic mass 20a remains stuck on the stop. There are very many approaches to reduce this sticking behavior, it being impossible, however, for these to increase the low restoring forces.

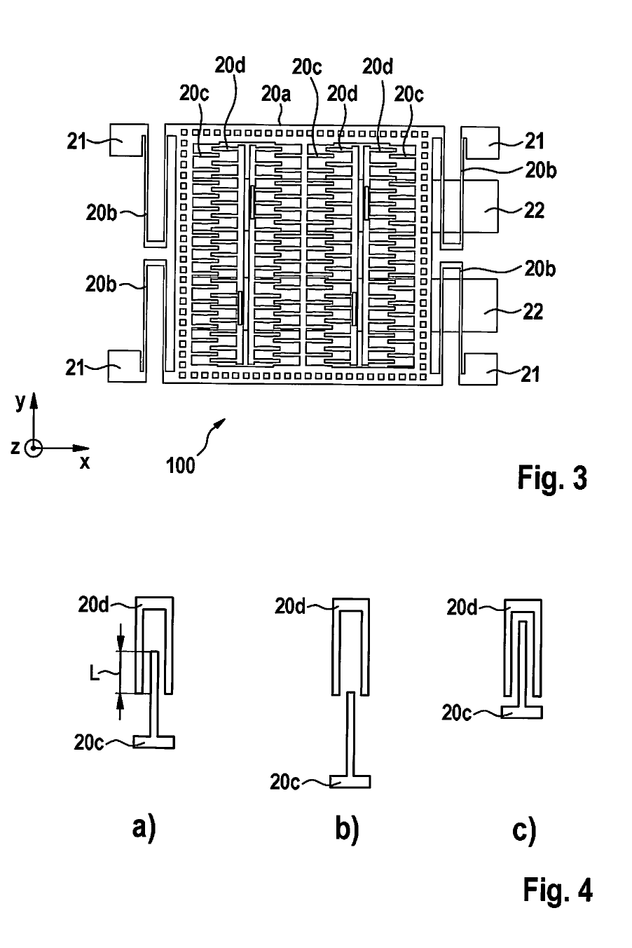

FIG. 3 shows a top view on a specific embodiment of a micromechanical inertial sensor 100 provided by the present invention. It may be seen that meshing comb structures of electrodes 20c, 20d are provided for detecting the deflection of the movable seismic mass 20a. Comb structures as capacitive detection structures are already known from other areas, but are hitherto unable to fulfill the aforementioned main requirements of high sensitivity. To make this possible and at the same time to preserve the other advantages of the comb structures, the following modifications are provided.

First, the present invention provides for a basic overlap or a sensing range L of the comb structures to be designed to be smaller than a maximum, mechanically possible deflection of the comb structures. This is shown in principle in FIG. 4, where different states of a comb structure of electrodes 20c, 20d are shown in three views a), b) and c). A second, stationary comb-shaped electrode 20d may be seen, which functionally interacts with the first, movable finger-shaped electrode 20c.

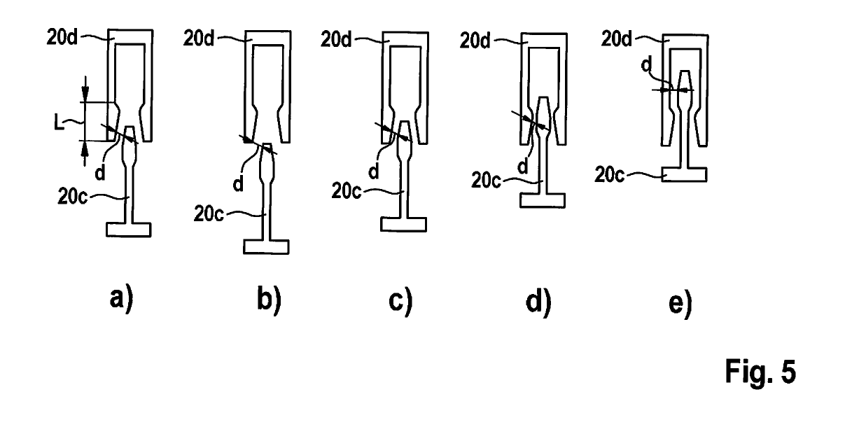

FIG. 5a shows that in an non-deflected basic position a penetration depth of first electrode 20c into second electrode 20d is less than 35%, preferably less than 25% of the total longitudinal extension of electrodes 20c, 20d. FIG. 5b shows a position of electrodes 20c, 20d that is due to a maximum negative acceleration, it being possible in this manner for first electrode 20c to be situated entirely outside of second electrode 20d. FIG. 5c shows a result of a maximum positive acceleration with respect to a measuring range, in particular of a linear measuring range of the sensor. FIG. 5e shows a result of a maximum positive acceleration, it being shown clearly that the deflection goes far beyond the measuring range.

FIG. 5 furthermore shows that it is also possible to vary the width of the comb fingers of electrodes 20c, 20d over the length of the fingers. In particular, it is possible for the fingers of first electrode 20c to be designed in such a way that the width of the space between the finger tip of a central area of the finger and the second electrode 20d decreases as second electrode 20d penetrates first electrode 20c so that a gap width d between electrodes 20c, 20d varies as first electrode 20c is immersed into the second electrode. It is possible to select the increase of the width of first electrode 20c to be so small that the fingers are able to deflect beyond the provided measuring range further into the counter-comb of second electrode 20d, as is shown in principle in FIGS. 5d and 5e.

It is further provided to use, particularly in the detection direction of the sensor, e.g., in the x-direction, substantially softer structures than hitherto and at the same time to suspend, in the directions perpendicular thereto, i.e., e.g., in the y-direction, the seismic mass 20a together with first electrodes 20c in a substantially more rigid manner.

It is further provided for the comb structures of electrodes 20c, 20d to be designed in such a way that they do not yet strike a mechanical stop in the event of an external acceleration that corresponds to the maximum measuring range.

There may furthermore be a provision, as shown in FIG. 5, for the finger of movable first electrode 20c to be predominantly of the same width or narrower in the rear area than the maximum width of the finger of electrode 20c in the front area.

Advantageously, due to a small finger overlap, in the event of a low basic capacitance, as shown in FIG. 5a, it is possible to achieve a high capacitance change per deflection. This advantageously makes it possible to use very low-noise electronic evaluation circuits.

Furthermore, a small finger overlap makes it advantageously possible that the full maximum measuring signal, as shown in FIG. 5c, is already achieved before the finger structure of electrode 20c is fully immersed in the comb structure of electrode 20d. This means that in the event of accelerations that go beyond the full measuring signal, the finger structure of electrode 20c is able to perform an even further immersion movement, as indicated in FIGS. 5d, 5e. The finger structure of electrode 20c will strike a stop only at accelerations that are considerably greater than the maximum measured acceleration. The restoring forces when striking a stop are thus much greater and it is thus advantageously possible to prevent sticking when striking a stop.

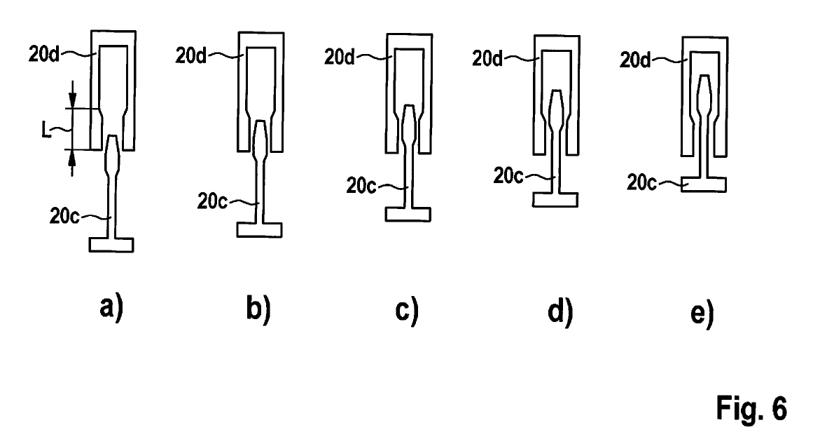

FIG. 6 shows further possible configurations of comb electrodes 20c, 20d. In contrast to the configuration shown in FIG. 5, in this case the foremost area of sensing range L of electrode 20d in the detection direction is designed to be parallel to the sensing direction, a widening in second electrode 20d being shown behind sensing range L.

Further variants of electrodes 20c, 20d that are not shown may also provide for only first electrode 20c or only second electrode 20d to have widening and narrowing sections.

These specific shapes of comb electrodes 20c, 20d explained above result in the following advantages:

Normal comb structures have a large basic capacitance and a small capacitance change. By contrast, the system provided in the present invention has a high sensitivity, which may be explained as follows:
The basic capacitance is reduced by the smaller basic overlap of electrodes 20c, 20d.
The capacitance change is increased by the change in the finger width. When electrodes 20c, 20d are immersed into each other, not only is the overlapping area of electrodes 20c, 20d increased, but rather, as in classical sensors, the distance between the electrodes is also reduced due to the finger shape.
Due to the softer suspension of the movable seismic mass 20a, the comb structures are able to immerse more deeply into each other.
Due to the mixed effect of surface area change and interspace change, the new comb structures are clearly more linear in the electrical output signal than conventional sensors. In particular, they make it possible to adjust the sensitivity characteristic curve by the shape of the fingers. It is thereby possible for example to produce a characteristic curve that is as linear as possible. It is also possible, however, to produce characteristic curves that become less sensitive at high accelerations so as to be able to cover a greater measuring range. To achieve this, one may in particular taper the fingers again also toward the back. Conventional sensors behave precisely in a contrary manner. In conventional sensors, the deviation from linearity has the consequence that precisely in interesting small accelerations they provide smaller signals, while in the case of large acceleration signals they provide an excessively large signal.

The comb structures of electrodes 20c, 20d may be designed in such a way that first electrodes 20c are able to be immersed into second electrodes 20d beyond the maximum sensing range L. In this manner, the restoring force may be adjusted by the geometry alone and may be set to be appropriately high.

Mechanical impact or stop elements (not shown in the figures), which prevent impact and thus a short circuit between electrodes 20c, 20d, may be designed in such a way that they reduce the maximum mechanical deflection of first electrodes 20c only negligibly. The mechanical stops may be designed as stop elements that allow for an approx. 90% immersion of first electrodes 20c into second electrodes 20d. In conventional sensors, the mentioned stops are typically designed in such a way that they become effective already after approx. two thirds of the length of the electrodes, which signifies a clear limitation of the freedom of movement, which is indeed necessary in conventional sensors.

In order to measure the capacitance, an electrical voltage must be applied to electrodes 20c, 20d, a restoring force of the movable seismic mass 20a increasing in a linear manner with the deflection. The force between electrodes 20c, 20d is extremely non-linear and at small electrical voltages therefore result in the so-called snap-in effect, which causes a high attractive force and results in electrodes 20c, 20d striking against each other.

In conventional comb electrodes, both forces have a linear behavior, which is why no snap-in effect occurs. In order to achieve this effect, it is advantageous to provide shapes of the electrodes that taper again toward the back or at least that do not become wider.

The comb structures of electrodes 20c, 20d provided in the present invention, by contrast, are insensitive to small deformations of the substrate. The movable seismic mass 20a is suspended more softly by spring elements 20b in the detection direction and deflects more strongly in this direction. A false signal, which is caused by a small shift of the electrodes, generates an accordingly smaller false signal.

It is thus advantageously possible, as shown in FIGS. 5, 6, that the shapes of first electrodes 20c and second electrodes 20d do not have to be identical. As shown in FIG. 6, it may be advantageous to provide different shapes for electrodes 20c, 20d. A system shall be mentioned as an example, which is to provide a very sensitive signal at small accelerations and at great accelerations a non-linear, less sensitive signal, in order to cover a measuring range that is as great as possible.

In this case it may be advantageous that only one of the two comb electrodes 20c, 20d have a shape whose width expands from the tip toward the center, while the second comb electrode may also have a shape whose width does not change or whose width even decreases. It may be seen that manifold shapes are possible for electrodes 20c, 20d that are not shown in figures.

The system is not limited to electrode pairs, in which one of the two electrodes 20c, 20d is fixed in place on the substrate. It is only important that the electrodes change their distance with respect to each other when an acceleration is applied.

The system is not limited to applications in which an external acceleration is measured, it being also possible to use this system to measure for example Coriolis accelerations in a rotation-rate sensor.

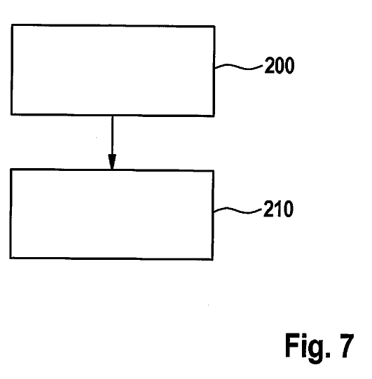

FIG. 7 shows a basic sequence of a provided method for manufacturing a micromechanical inertial sensor 100.

In a step 200, a movable seismic mass 20a fixed in position on a substrate and having comb-like first electrodes 20c is provided.

In a step 210, second electrodes 20d fixed in position on the substrate are provided, the electrodes 20c, 20d being designed in such a way that, when no external acceleration is applied, an overlap L of first electrodes 20c with second electrodes 20d in the sensing direction is definably small and amounts to less than approx. 35%, preferably less than approx. 25%.

Although the present invention was described above with reference to concrete exemplary embodiments, one skilled in the art is also able to implement specific embodiments that were not disclosed above or that were disclosed above only partially, without deviating from the essence of the invention.

What is claimed is:

1. A micromechanical inertial sensor, comprising:
a movable seismic mass fixed in position on a substrate and having comb-like first electrodes;
second electrodes fixed in position on the substrate, the electrodes being designed in such a way that, when no external acceleration is applied, an overlap of the first electrodes with the second electrodes in the sensing direction is definably small and amounts to less than approx. 35%.

2. The micromechanical inertial sensor as recited in claim 1, wherein the overlap is less than approx. 25%.

3. The micromechanical inertial sensor as recited in claim 1, wherein in the event of a maximum negative acceleration with respect to a measuring range of the inertial sensor, the overlap of the first electrodes with the second electrodes in the sensing direction is of such a kind that one of: (i) end sections of the first electrodes and of the second electrodes overlap in a definably small manner, or (ii) they are spaced apart from each other less than a distance between the end sections of the first and second electrodes.

4. The micromechanical inertial sensor as recited in claim 1, wherein at least one section of the first and/or the second electrodes is not in parallel to the sensing direction, and the section that is not developed in parallel to the sensing direction does not mechanically limit the movement of the first and/or the second electrodes in the sensing direction.

5. The micromechanical inertial sensor as recited in claim 1, wherein at least one portion of the second electrode is developed in such a way that a width of the second electrodes in the sensing direction behind a sensing range is designed to be uniformly wide or increasing in width.

6. The micromechanical inertial sensor as recited in claim 1, wherein the seismic mass is attached to the substrate by spring elements, the spring elements being designed in such a way that a spring stiffness in the sensing direction is definably soft and orthogonal to the sensing direction is designed to be definably hard.

7. The micromechanical inertial sensor as recited in claim 1, wherein at least one portion of the first or the second electrode in a region of the overlap in the normal state is designed in such a way that the distance between the electrodes is reduced in a subsection when the electrodes are immersed into each other in the sensing direction.

8. The micromechanical inertial sensor as recited in claim 1, wherein at least one portion of the first or the second electrodes in a region outside of the overlap in the normal state is designed in such a way that the distance between the electrodes increases in a subsection when the electrodes are immersed into one another in the sensing direction.

9. The micromechanical inertial sensor as recited in claim 1, wherein stop elements are provided, the stop elements being able to limit an immersion depth of the second electrodes into the first electrodes.

10. A method for manufacturing a micromechanical inertial sensor, comprising:
providing a movable seismic mass fixed in position on a substrate and having comb-like first electrodes; and
providing second electrodes fixed in position on the substrate, the electrodes being designed in such a way that, when no external acceleration is applied, an overlap of the first electrodes with the second electrodes in the sensing direction is definably small and amounts to less than approx. 35%.

11. The method as recited in claim 10, wherein the overlap is less than approx. 25%.
